(19) United States
(12) Patent Application Publication
(10) Pub. No.: US 2014/0085217 A1
(43) Pub. Date: Mar. 27, 2014

(54) ELECTRONIC APPARATUS AND CONTROL METHOD THEREOF

(71) Applicant: HTC CORPORATION, Taoyuan County (TW)

(72) Inventors: Hsiao-Chuan Huang, Taoyuan County (TW); Tsung-Hwa Yang, Taoyuan County (TW); Yuan-Hung Chang, Taoyuan County (TW); Chih-Shan Yeh, Taoyuan County (TW)

(73) Assignee: HTC CORPORATION, Taoyuan County (TW)

(21) Appl. No.: 13/628,062

(22) Filed: Sep. 27, 2012

(51) Int. Cl. G06F 3/041

(52) U.S. Cl. CPC G06F 3/041
USPC 345/173

(57) ABSTRACT

An electronic apparatus and a control method thereof are provided. The electronic apparatus includes a case, a touch sensor, a strength sensor and a controller. The touch sensor is disposed at the case and capable of sensing whether the case is touched. The strength sensor is disposed at the case and capable of sensing whether the case is pressed. The controller is disposed in the case and electrically couple to the touch sensor and the strength sensor. According to the touch sensor for sensing whether the case is touched and according to the strength sensor for sensing whether the case is pressed, the controller produces a control signal.

### BACKGROUND

1. Field of the Disclosure

The disclosure generally relates to an electronic apparatus and a control method thereof, and more particularly, to an electronic apparatus with a touch sensor and a strength sensor and a control method thereof

2. Description of Related Art

With the development of science and technology, many consumer electronic apparatuses are available on the market, such as mobile phones, tablet computers and e-books. These electronic apparatuses are not only to facilitate the lives of people, but also to play an indispensable role in the life, and these electronic apparatuses have a smaller size and a light weight in order to easily carry by handholding.

Taking the mobile phone as an example, with the progress of the touch display technology, the mobile phone's touching display function has gradually replaced the function of the traditional physical keys. Further, in order to achieve the purpose of usage convenience, still some physical keys are used and disposed on the case of the mobile phone for controlling different function. For example, the physical key for controlling volume is disposed on a side surface of the case to allow the user to facilitate adjusting the volume during the call. However, when too many physical keys are disposed on the electronic apparatus, the disadvantages are obvious that the aesthetic feeling of overall appearance is spoiled and it prevents the overall thinner design of the electronic apparatus.

### SUMMARY OF THE DISCLOSURE

Accordingly, the disclosure is directed to an electronic apparatus, which has virtual keys to replace the traditional physical keys for producing a control signal.

The disclosure is also directed to a control method, which is capable of producing a control signal by using the virtual keys of the electronic apparatus to replace the traditional physical keys.

The disclosure provides an electronic apparatus, which includes a case, a touch sensor, a strength sensor and a controller. The touch sensor is disposed at the case and capable of sensing whether the case is touched. The strength sensor is disposed at the case and capable of sensing whether the case is pressed. The controller is disposed in the case and electrically couple to the touch sensor and the strength sensor. According to the touch sensor for sensing whether the case is touched and according to the strength sensor for sensing whether the case is pressed, the controller produces a control signal.

The disclosure provides a control method adapted to an electronic apparatus. The electronic apparatus includes a case, a touch sensor, a strength sensor and a controller. The touch sensor, the strength sensor and the controller are disposed at the case, and the controller is electrically couple to the touch sensor and the strength sensor. The touch sensor senses whether the case is touched and the strength sensor senses whether the case is pressed. According to the touch sensor for sensing whether the case is touched and according to the strength sensor for sensing whether the case is pressed, the controller produces a control signal.

Based on the description above, the electronic apparatus of the disclosure has a touch sensor, a strength sensor and a controller all disposed at the case. The touch sensor is capable of sensing whether the case is touched, the strength sensor is capable of sensing whether the case is pressed and the controller is capable of producing a control signal to execute a specific function, for example, a power switching function, a volume adjusting function or a frame scrolling function. Using the above-mentioned design, the touch sensor and the strength sensor can replace the traditional physical keys to make the electronic apparatus have better appearance and to facilitate forming a thinner shape.

In order to make the features and advantages of the present disclosure more comprehensible, the present disclosure is further described in detail in the following with reference to the embodiments and the accompanying drawings.

### BRIEF DESCRIPTION OF THE DRAWINGS

FIG. 1 is a schematic diagram of an electronic apparatus according to an embodiment of the disclosure.

FIG. 2 is a diagram showing an operation state of the electronic apparatus of Fig.

FIG. 3 is a diagram showing another operation state of the electronic apparatus of FIG. 1.

FIG. 4 is a flowchart of a control method used in an electronic apparatus according to an embodiment of the disclosure.

FIG. 5 is a diagram showing yet another operation state of the electronic apparatus of FIG. 1.

FIG. 6 is a flowchart of a control method used in an electronic apparatus according to another embodiment of the disclosure.

FIG. 7 is a flowchart of a control method used in an electronic apparatus according to yet another embodiment of the disclosure.

### DESCRIPTION OF THE EMBODIMENTS

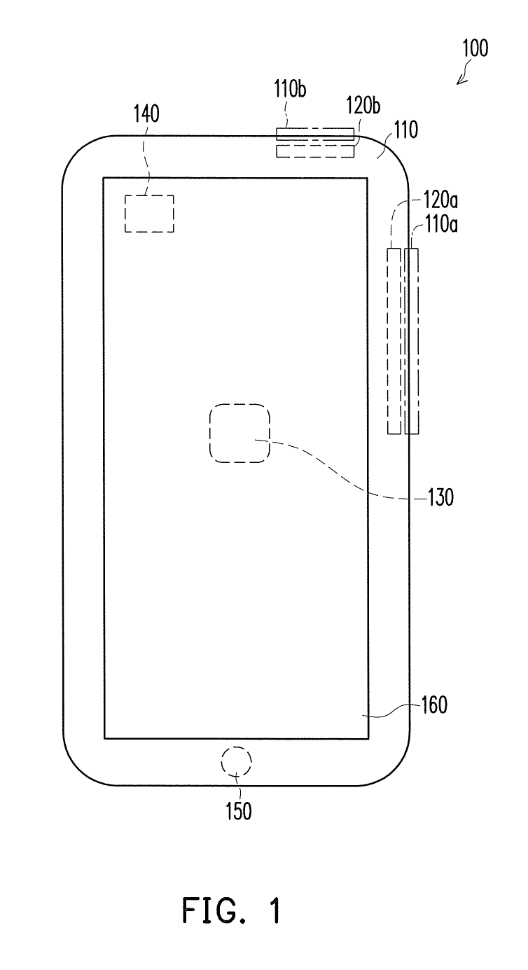

FIG. 1 is a schematic diagram of an electronic apparatus according to an embodiment of the disclosure. Referring to FIG. 1, in the embodiment, the electronic apparatus 100 includes a case 110, a touch sensor 120a, a strength sensor 130 and a controller 140. The electronic apparatus 100 is, for example, a smart phone, a notebook computer, a tablet computer or an eBook. The touch sensor 120a may be a conductive material such as indium tin oxide film (ITO film) or copper foil and the strength sensor 130 is, for example, a strain gage.

The touch sensor 120a is disposed in the case 110 and capable of sensing whether the case 110 is touched. The strength sensor 130 is disposed in the case 110 and capable of sensing whether the case 110 is pressed. The controller 140 is disposed in the case 110 and electrically couple to the touch sensor 120a and the strength sensor 130. According to the touch sensor 120a for sensing whether the case 110 is touched and according to the strength sensor 130 for sensing whether the case 110 is pressed, the controller produces a control signal produces a control signal to execute a specific function, for example, a power switching function, a volume adjusting function or a screen scrolling function.

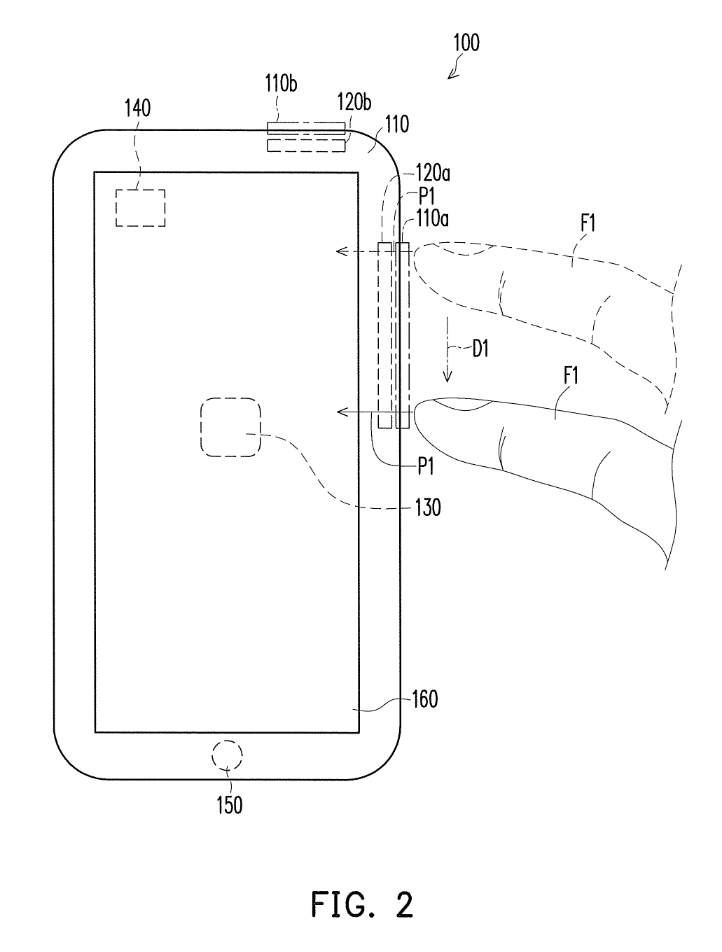

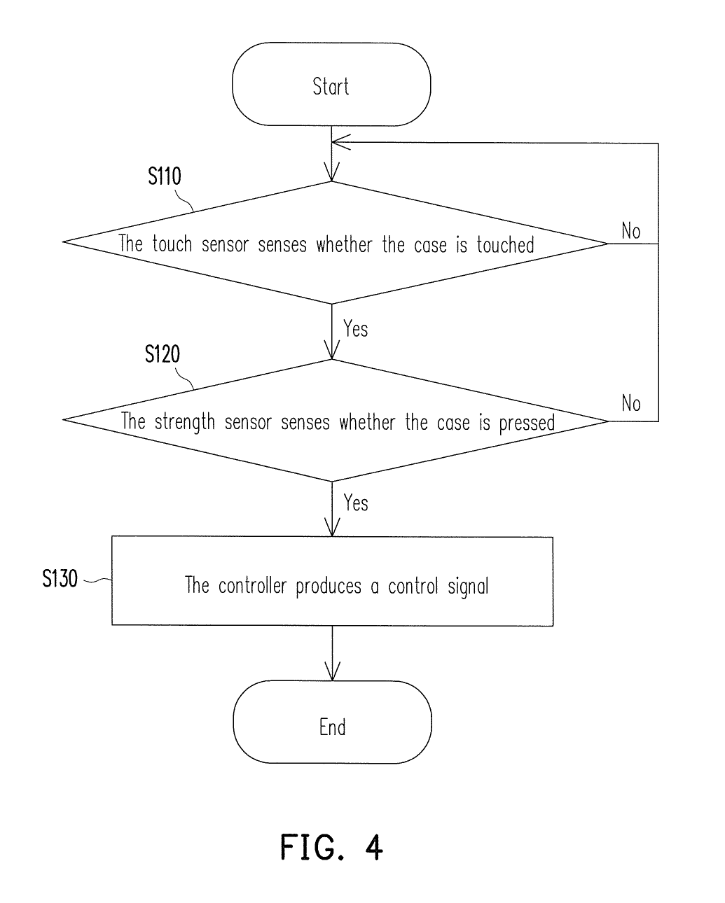

FIG. 2 is a diagram showing an operation state of the electronic apparatus of FIG. 1 and FIG. 4 is a flowchart of a control method used in an electronic apparatus according to an embodiment of the disclosure. Referring to FIGS. 1, 2 and 4, in more details, after the electronic apparatus 100 is turned on, the touch sensor 120a and the strength sensor 130 start sensing the case 110. Then in step S 110, when a finger F1 touches the touch sensor 120a, the touch sensor 120a can sense out the case 110 is touched and the touch sensor 120a delivers a touching signal to the controller 140. On the contrary, when the finger F1 does not touch the touch sensor 120a, the touch sensor 120a continues sensing. After that in step S120, after the finger F1 touches the touch sensor 120a, the strength sensor 130 can sense whether the case 110 is suffered by a pressing force P1. When the strength sensor 130 senses out the finger F1 presses against the case 110 with the pressing force P1, the strength sensor 130 delivers a pressing signal to the controller 140. On the contrary, when the finger F1 does not press against the case 110, the strength sensor 130 continues sensing. Further in step S130, when the touch sensor 120a senses out the case 110 is touched and delivers a touching signal to the controller 140, and the strength sensor 130 senses out the finger F1 presses against the case 110 with the pressing force P1 and delivers a pressing signal to the controller 140, the controller 140 produces a control signal, in which the control signal may be a power switching signal, a volume adjusting signal or a frame scrolling signal. At the time, an electronic component of the electronic apparatus 100 receives the control signal, and the electronic component is driven to start the corresponding function.

The electronic apparatus 100 of the embodiment, for example, further includes a speaker 150 disposed in the case 110 and electrically couple to the controller 140. After the touch sensor 120a senses out the case 110 is touched and the strength sensor 130 senses out the case 110 is pressed against with the pressing force P1, the control signal (volume adjusting signal) produced by the controller 140 is delivered to the speaker 150 for adjusting the volume of the speaker 150.

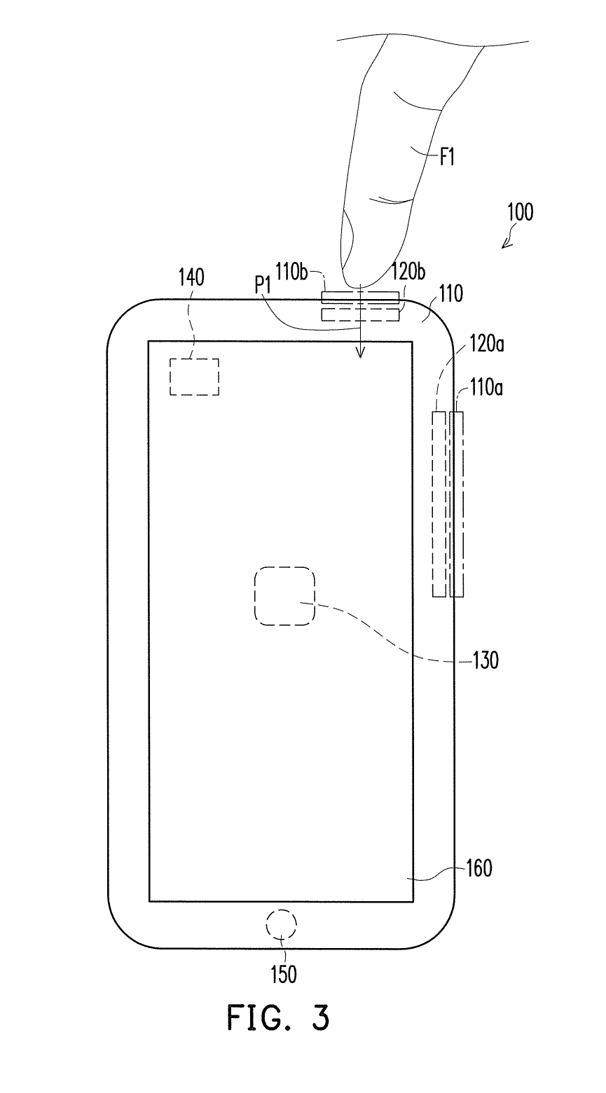

FIG. 3 is a diagram showing another operation state of the electronic apparatus of FIG. 1. Referring to FIGS. 1, 3 and 4, the electronic apparatus 100 of the embodiment further includes a display 160 disposed on the case 110 and electrically couple to the controller 140. Therefore, after the touch sensor 120b senses out the case 110 is touched and the strength sensor 130 senses out the case 110 is pressed against with the pressing force P1, the control signal (power switching signal) produced by the controller 140 is delivered to the display 160 for turning on or off the display 160. In this way, the touch sensor 120 and the strength sensor 130 form a virtual key to provide functions of the conventional physical keys. Therefore, the physical keys disposed on the surface of the case 110 can be reduced to maintain the aesthetic feeling of overall appearance of the electronic apparatus 100. In addition, since no more physical key is on the surface of the case 110, it also facilitates Ruining a thinner shape.

Referring to FIGS. 1, 2 and 3, the case 110 in the embodiment may have two specific areas 110a and 110b. The touch sensors 120a and 120b are, corresponding to the specific areas 110a and 110b, disposed in the case 110 and can sense whether the specific areas 110a and 110b of the case 110 are touched. When the touch sensors 120a and 120b sense out the specific areas 110a and 110b of the case 110 are touched and the strength sensor 130 senses out the case 110 is suffered by the pressing force which is greater than a threshold, the controller 140 produces the control signal, in which the threshold is, for example, an amount of deformation.

For example, when the finger F1 does not touch the case 110 at the specific area 110a, the touch sensor 120a will not deliver the touching signal to the controller 140. After the finger F1 touches the case 110 at the specific area 110a and the pressing force of the finger F1 produces a deformation with the case 110, the touch sensor 120a and the strength sensor 130 respectively deliver the touching signal and the pressing signal to the controller 140. When the deformation of the case 110 is greater than the threshold (deformation amount) of the controller 140, the controller 140 produces the control signal. As a result, by that the finger F1 touches the specific area 110a of the case 110 and the pressing force of the case 110 is greater than the threshold of the controller 140, it can avoid a wrong action of the corresponding electronic component due to mis-touching the controller 140.

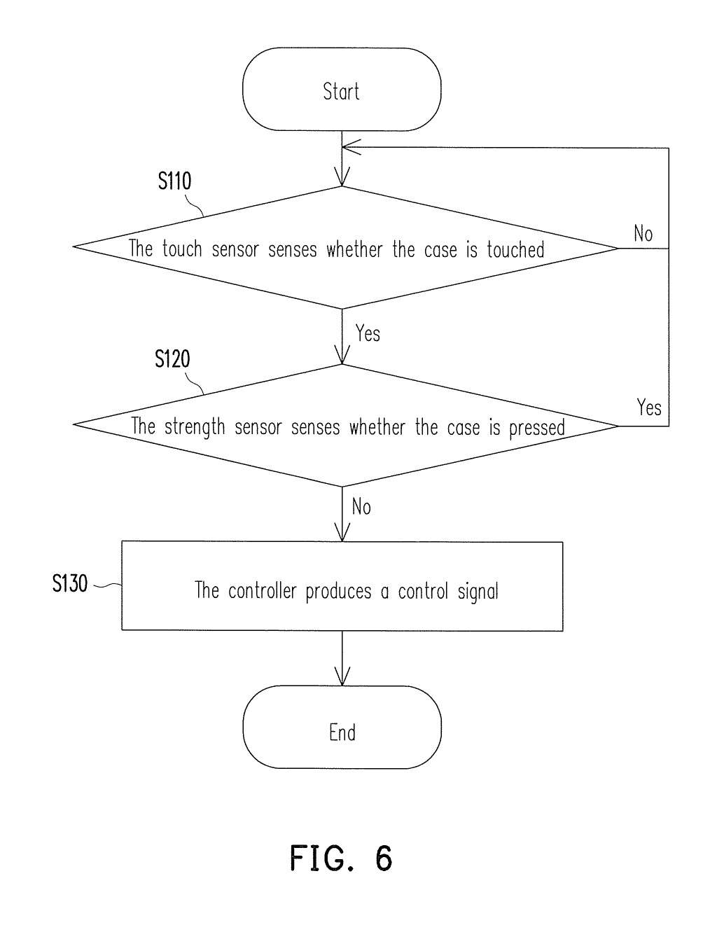

In addition, under the following cases, the controller 140 in the embodiment can also produce a control signal. FIG. 6 is a flowchart of a control method used in an electronic apparatus according to another embodiment of the disclosure. Referring to FIGS. 2 and 6, the control method in the embodiment is similar to the control method of FIG. 4, and only the difference is described, in which the same or similar notations represent the same or similar method, which is omitted to describe. When the touch sensors 120a and 120b sense out the specific areas 110a and 110b of the case 110 are touched and the strength sensor 130 senses out the pressing force of the case 110 is less than a threshold, the controller 140 also produces the control signal. In other words, at the time, the touch sensors 120a and 120b may sense out the case 110 are touched, but the strength sensor 130, due to too small pressing force, does not sense out the case 110 is pressed. For example, when the finger F1 slightly touch the specific areas 110a and 110 of the case 110, the controller 140 still can produce the control signal, and the electronic apparatus 100 can control the display 160 for scrolling the screen according to the control signal.

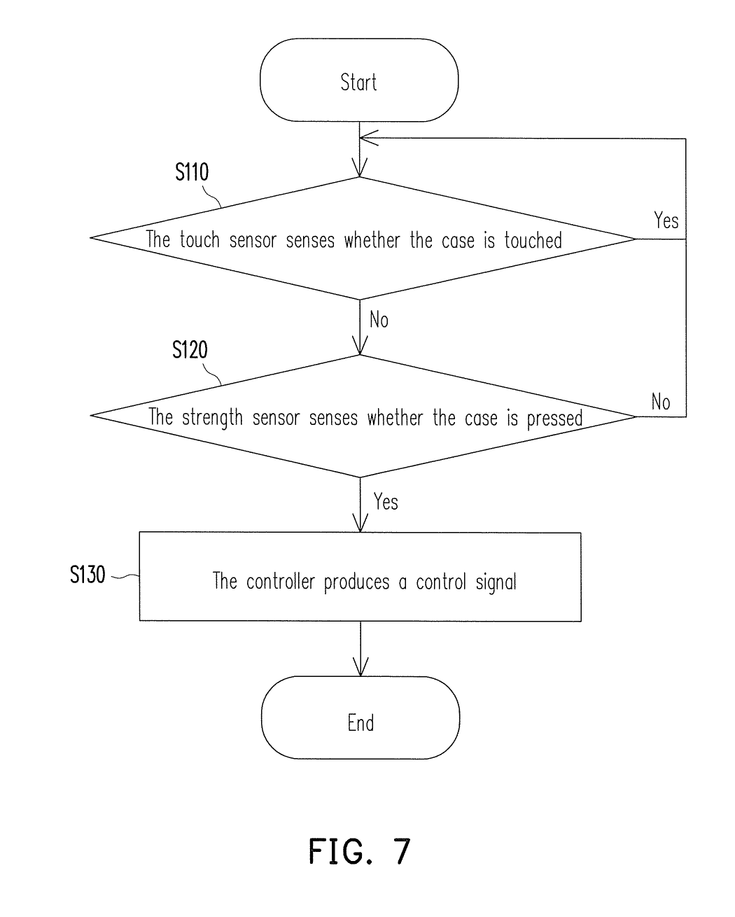

FIG. 7 is a flowchart of a control method used in an electronic apparatus according to yet another embodiment of the disclosure. Referring to FIGS. 2 and 7, the control method in the embodiment is similar to the control method of FIG. 4, and only the difference is described, in which the same or similar notations represent the same or similar method, which is omitted to describe. When the touch sensors 120a and 120b do not sense out the specific areas 110a and 110b of the case 110 are touched but the strength sensor 130 senses out the pressing force of the case 110 is greater than a threshold, the controller 140 also produces the control signal. For example, when the finger F1 presses forcibly an area out of the specific areas 110a and 110b of the case 110, the controller 140 still can produce the control signal which makes the electronic apparatus 100 turn on or off the display 160.

In addition, the touch sensor 120a in the embodiment is capable of sensing whether the touching point on the case 110 moves. When the touch sensor 120a senses out the touching point on the case 110 moves, the controller 140 would produce the control signal according to the moving direction of the touching point. For example, after the controller 140 produces the control signal to adjust the volume of the speaker 150 and the finger F1 moves along a first direction D1 parallel to the longitudinal direction of the case 110, the control signal of the controller 140 drives the speaker 150 to adjust the volume.

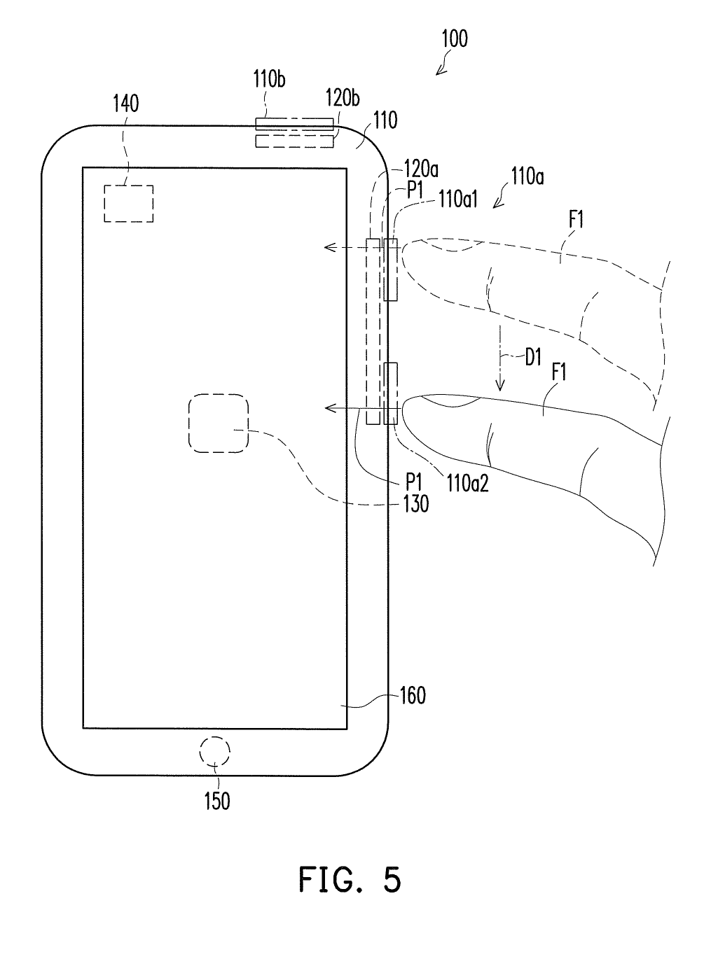

FIG. 5 is a diagram showing yet another operation state of the electronic apparatus of FIG. 1. Referring to FIG. 5, in another embodiment, the specific area 110a is divided into a plurality of sub-areas 110a1 and 110a2, and the touch sensor 120a is capable of sensing out the touching positions of the sub-areas 110a1 and 110a2 on the case 110. When the touch sensor 120a senses out the touching positions on the case 110, the controller 140 produces the control signal according to the sub-areas 110a1 and 110a2. For example, when the finger F1 touches the sub-area 110a1, the controller 140 produces the control signal for increasing the volume of the speaker 150. On the contrary, when the finger F1 touches the sub-area 110a2, the controller 140 produces the control signal for decreasing the volume of the speaker 150.

In summary, the touch sensor of the disclosure is capable of sensing whether the case is touched, the strength sensor is capable of sensing whether the case is pressed. Therefore, under different cases, the controller can produce different control signal corresponding to different electronic component. Using the above-mentioned design, the touch sensor and the strength sensor can form a virtual key to provide the functions of the conventional physical keys, which can reduce the physical keys disposed on the case to maintain the aesthetic feeling of appearance of the electronic apparatus. In addition, since no more physical key is on the surface of the case, it also facilitates forming a thinner shape. In addition, when the touch sensor is disposed at a specific area of the case and the pressing force the of case is greater than the threshold of the controller, it can avoid wrong action of the corresponding electronic component due to mis-touching the controller.

It will be apparent to those skilled in the art that the descriptions above are several preferred embodiments of the disclosure only, which does not limit the implementing range of the disclosure. Various modifications and variations can be made to the structure of the disclosure without departing from the scope or spirit of the disclosure. The claim scope of the disclosure is defined by the claims hereinafter.

What is claimed is:

1. An electronic apparatus, comprising:
a case;
a touch sensor, assembled to the case and capable of sensing whether the case is touched;
a strength sensor, assembled to the case and capable of sensing whether the case is pressed; and
a controller, disposed in the case and electrically couple to the touch sensor and the strength sensor to sense whether the case is touched according to the touch sensor and whether the case is pressed according to the strength sensor so as to produce a control signal.

2. The electronic apparatus as claimed in claim 1, wherein when the touch sensor senses out the case is touched and the strength sensor senses out the case is pressed, the controller produces the control signal.

3. The electronic apparatus as claimed in claim 1, wherein when the touch sensor senses out the case is touched but the strength sensor does not sense out the case is pressed, the controller produces the control signal.

4. The electronic apparatus as claimed in claim 1, wherein when the touch sensor does not sense out the case is touched and the strength sensor senses out the case is pressed, the controller produces the control signal.

5. The electronic apparatus as claimed in claim 1, wherein the case has a specific area, the position of the touch sensor is corresponding to the specific area and the touch sensor is capable of sensing whether the specific area of the case is touched, when the touch sensor senses out the specific area of the case is touched and the strength sensor senses out the case is suffered by a pressing force which is greater than a threshold, the controller produces the control signal.

6. The electronic apparatus as claimed in claim 1, wherein the case has a specific area, the position of the touch sensor is corresponding to the specific area and the touch sensor is capable of sensing whether the specific area of the case is touched, when the touch sensor does not sense out the specific area of the case is touched and the strength sensor senses out the case is suffered by a pressing force which is greater than a threshold, the controller produces the control signal.

7. The electronic apparatus as claimed in claim 1, wherein the case has a specific area, the position of the touch sensor is corresponding to the specific area and the touch sensor is capable of sensing whether the specific area of the case is touched, when the touch sensor senses out the specific area of the case is touched and the strength sensor senses out the case is suffered by a pressing force which is less than a threshold, the controller produces the control signal.

8. The electronic apparatus as claimed in claim 1, wherein the touch sensor is capable of sensing whether touching point on the case moves, when the touch sensor senses out the touching point on the case moves, the controller produces the control signal according to the movement of the touching point.

9. The electronic apparatus as claimed in claim 1, wherein the control signal comprises a power switching signal, a volume adjusting signal or a screen scrolling signal.

10. The electronic apparatus as claimed in claim 1, further comprising:
a display, disposed on the case and electrically couple to the controller, wherein the control signal produced by controller is capable of turning on or off the display.

11. The electronic apparatus as claimed in claim 1, further comprising:
a speaker, disposed on the case and electrically couple to the controller, wherein the control signal produced by controller is capable of adjusting volume of the speaker.

12. A control method, adapted to an electronic apparatus, wherein the electronic apparatus comprises a case, a touch sensor, a strength sensor and a controller, the touch sensor, the strength sensor and the controller are assembled to the case, and the controller is electrically couple to the touch sensor and the strength sensor; the control method comprising:
sensing whether the case is touched by the touch sensor;
sensing whether the case is pressed by the strength sensor; and
producing a control signal by the controller according to the touch sensor for sensing whether the case is touched and according to the strength sensor for sensing whether the case is pressed.

13. The control method as claimed in claim 12, wherein when the touch sensor senses out the case is touched and the strength sensor senses out the case is pressed, producing the control signal by the controller.

14. The control method as claimed in claim 12, wherein when the touch sensor does not sense out the case is touched and the strength sensor senses out the case is pressed, producing the control signal by the controller.

15. The control method as claimed in claim 12, wherein when the touch sensor senses out the case is touched but the strength sensor does not sense out the case is pressed, producing the control signal by the controller.

16. The control method as claimed in claim 12, wherein the case has a specific area, the position of the touch sensor is corresponding to the specific area and the touch sensor is capable of sensing whether the specific area of the case is touched, when the touch sensor senses out the specific area of the case is touched and the strength sensor senses out the case is suffered by a pressing force which is greater than a threshold, producing the control signal by the controller.

17. The control method as claimed in claim 12, wherein the case has a specific area, the position of the touch sensor is corresponding to the specific area and the touch sensor is capable of sensing whether the specific area of the case is touched, when the touch sensor does not sense out the specific area of the case is touched and the strength sensor senses out the case is suffered by a pressing force which is greater than a threshold, producing the control signal by the controller.

18. The control method as claimed in claim 12, wherein the case has a specific area, the position of the touch sensor is corresponding to the specific area and the touch sensor is capable of sensing whether the specific area of the case is touched, when the touch sensor senses out the specific area of the case is touched and the strength sensor senses out the case is suffered by a pressing force which is less than a threshold, producing the control signal by the controller.

19. The control method as claimed in claim 12, wherein the control signal comprises a power switching signal, a volume adjusting signal or a screen scrolling signal.

20. The control method as claimed in claim 12, wherein the touch sensor senses whether touching point on the case moves, when the touch sensor senses out the touching point on the case moves, producing the control signal by the controller according to the movement of the touching point.

21. The control method as claimed in claim 12, wherein the control signal produced by controller is capable of turning on or off a display of the electronic apparatus.

22. The control method as claimed in claim 12, wherein the control signal produced by controller is capable of adjusting volume of a speaker of the electronic apparatus.
